(19) United States
(12) Patent Application Publication
(10) Pub. No.: US 2002/0167496 A1
(43) Pub. Date: Nov. 14, 2002

(54) Marking devices for digital transcription systems

(76) Inventors: Yao Ding, Mountain View, CA (US); Rafi Holtzman, San Mateo, CA (US)

Correspondence Address: James Trosino, Suite 2000, #20003, One Sansome Street, San Francisco, CA, 94104, US

(21) Appl. No.: 10/178,152

(22) Filed: Jun. 24, 2002

Related U.S. Application Data
(63) Continuation-in-part of application No. 09/916,558, filed on Jul. 26, 2001, now Pat. No. 6,424,340.
Application No. 09/916,558 is a continuation of application No. 08/811,947, filed on Mar. 5, 1997, now Pat. No. 6,292,177.

(51) Int. Cl. G09G 5/00

(52) U.S. Cl. 345/173

(57) ABSTRACT

A marking device for digital transcription systems provides a transmitter marking device that is comprised of a modular holder and sleeve. The sleeve is a “smart” sleeve that identifies the color of an inserted drawing implement to the holder. The holder is detachable from the sleeve and houses a battery, electronic circuit, and pressure sensitive switches. The electronic circuit controls the electrical functions of the transmitter marking device and contains electronic circuitry that controls the transmitter device's power and varies the IR transmitter signal by varying the number and duration of the IR pulses as the battery voltage level changes.

### CROSS-REFERENCE TO RELATED APPLICATIONS

This application is a continuation-in-part of U.S. Application Serial No. 09/916,558 filed Jul. 26, 2001, now U.S. Pat. No.___,___, which is a continuation of U.S. Application Serial No. 08/811,947, filed Mar. 5, 1997, now U.S. Pat. No. 6,292,177.

### FIELD OF THE INVENTION

The invention relates to digital transcription systems. More particularly, the invention relates to drawing devices used in digital transcription systems.

### DESCRIPTION OF THE PRIOR ART

It is known to use various techniques for determining the position of a writing implement or stylus on a flat surface. Glenn et al. U.S. Pat. No. 4,564,928, Suzuki et al. U.S. Pat. No. 4,886,943, Kobayashi et al. U.S. Pat. Nos. 4,910,363 and 5,073,685, and Yoshimura et al. U.S. Pat. No. 5,097,102, all disclose systems in which a vibrating element associated with a pen transmits vibrations through the material of a writing surface board. The vibrations are detected by transducers attached to the board, and the pen position is calculated from the transmission time of the vibrations through the board. These systems inherently function exclusively when the pen is in contact with the board such that vibrations are transferred to the board. As a result, no special mechanism is required to distinguish writing from non-writing pen movements.

These previously known systems are generally inaccurate, however, due to non-uniform transmission times through the board. In fact, they typically require highly specialized board structures which renders the systems expensive and inconvenient.

An alternative approach is the use of air-borne ultrasound signals. Examples of such systems are described in Mallicoat U.S. Pat. No. 4,777,329, Stefik et al. U.S. Pat. No. 4,814,552, Hansen U.S. Pat. No. 4,506,354, and De Bruyne U.S. Pat. No. 4,758,691. These systems employ various combinations of ultrasound transmitters and receivers arranged at two points fixed relative to a board and on a movable writing implement. The position of the movable implement is then derived by triangulation. The systems typically require an additional hard-wired or electromagnetic link between the movable implement and a base unit to provide timing information for time-of-flight ultrasound calculations. An additional switch is also required to identify when the movable element is in contact with the board.

Because of signal to noise ratio (SNR) limitations, these previously known systems are typically limited to relatively small boards. The ultrasound volume of such systems cannot be very high without causing bothersome accompanying whistling noises. Additionally, in a wireless system, power considerations severely limit the transmitted volume. To generate reliable position information, the transmitter-to-receiver distance must therefore be kept small. Attempts to use different sets of receivers for different regions of a large board generally result in discontinuities when the movable element travels from one region to another.

Another shortcoming of these previously known systems is their inability to reproduce rapid interrupted pen strokes such as performed when drawing a dashed line. Typically, the transmitter or receiver element in the pen turns OFF when the pen is inactive and is re-activated each time the pen comes in contact with the board. The system then takes a fraction of a second to resynchronize before it responds correctly. In the case of short strokes, the length of the operative stroke may be comparable with the response time of the system, thereby giving very poor results.

An additional problem of the previously known airborne ultrasound digitizer systems is that the ultrasound transmitter or receiver element is mounted asymmetrically to the side of the drawing implement. As a result, the measured position is offset from the true drawing position in a direction which changes with rotation of the drawing implement. This may result in discontinuities and illegible writing in the digitized images when the drawing implement position is changed between strokes.

In addition, previously known electronic transcription systems typically have required the use of multiple transmitter devices to permit the use of different colored drawing implements. In particular, each transmitter device typically may only be used with drawing implements of a specific color. Thus, for a four-color electronic transcription system, previously known systems have required four separate transmitter devices, which has increased system costs. It would be desirable to provide electronic transcription systems that may be used with multiple-colored drawing implements, but not require a unique transmitter device for each color.

Further, previously known electronic transcription systems include transmitter devices that operate by battery power. In some previously known systems, electronic circuitry in the transmitter devices continues to operate even though the device is not in use. Because battery life is limited, such previously known systems suffer the disadvantage of limited battery life. It would also be desirable, therefore, to provide apparatus and methods for extending battery life in electronic transcription systems.

In addition, previously known electronic transcription systems often use voltage regulators to ensure that the voltage provided to the ultrasound and IR transmitters remains constant, even as battery voltage varies. One problem with this approach is that the cost of the transmitter device is higher due to the voltage regulator. It further would be desirable to provide electronic transcription systems that do not require a voltage regulator for transmitter electronics.

### SUMMARY OF THE INVENTION

In view of the foregoing, it is an object of this invention to provide electronic transcription systems that may be used with multiple-colored drawing implements, but not require a unique transmitter device for each color.

It also is an object of this invention to provide apparatus and methods for extending battery life in electronic transcription systems.

It further is an object of this invention to provide electronic transcription systems that do not require a voltage regulator for transmitter electronics.

These and other objects of the present invention are accomplished by providing a marking device for digital transcription systems provides a transmitter marking device that is comprised of a modular retainer and sleeve. The sleeve is a “smart” sleeve that identifies the color of an inserted drawing implement to the retainer. The holder is detachable from the sleeve and houses a battery, electronic circuit, and pressure sensitive switches. The electronic circuit controls the electrical functions of the transmitter marking device and contains electronic circuitry that controls the transmitter device's power and varies the IR transmitter signal by varying the number and duration of the IR pulses as the battery voltage level changes.

Other aspects and advantages of the invention will become apparent from the following detailed description in combination with the accompanying drawings, illustrating, by way of example, the principles of the invention.

### BRIEF DESCRIPTION OF THE DRAWINGS

The above-mentioned objects and features of this invention can be more clearly understood from the following detailed description considered in conjunction with the following drawings, in which the same reference numerals denote the same structural elements throughout, and in which:

FIG. 1 is a schematic front view of a presentation board provided with a digitizer system, constructed and operative according to the teachings of the present invention, showing a switch-over zone between regions with different groups of ultrasound receivers;

FIG. 2 is a plot illustrating the variation of relative weighting of position indications from two sets of ultrasound receivers in FIG. 1 as a function of position across the presentation board;

FIG. 3 is a side view of a twin ultrasound receiver assembly for use in a presentation board digitizer system constructed and operative according to the teachings of the present invention;

FIG. 4 is a schematic representation of the reception characteristic of the twin ultrasound receiver assembly of FIG. 3;

FIG. 5 is a side cross-sectional view of an exemplary transmitter device, constructed and operative according to the teachings of the present invention, used with a conventional drawing implement in a digitizer system;

FIG. 6A is an exploded perspective view of a microswitch structure, constructed and operative according to the teachings of the present invention, for use in the transmitter device of FIG. 5;

FIG. 6B is a perspective view of the microswitch structure of FIG. 6A assembled;

FIG. 6C is a top view of the microswitch structure of FIG. 6A showing a retaining spring arrangement;

FIG. 7 is a schematic perspective view of a preferred structure for attachment of a retaining member to a housing for use in the transmitter device of FIG.5;

FIG. 8 shows an alternative exemplary embodiment of a transmitting device in accordance with this invention;

FIGS. 9A and 9B show two different forms of the upper biasing element;

FIG. 10A is a plot of the output of a contact switch activated by operational contact between a drawing implement and a presentation board as a function of time;

FIG. 10B illustrates the recorded drawing implement operation time profile produced by prior art systems corresponding to the contact profile of FIG. 10A;

FIG. 10C illustrates the corresponding recorded drawing implement operation time profile produced according to a first embodiment of a presentation board digitizer system, constructed and operative according to the teachings of the present invention;

FIG. 11 is a side cross-sectional view of an exemplary eraser transmitter unit, constructed and operative according to the teachings of the present invention, for use with a digitizer system;

FIG. 12 shows an alternative exemplary embodiment of an eraser in accordance with this invention;

FIG. 13 illustrates the signals received by air-borne ultrasound receivers and a board-mounted transducer, respectively, according to a second embodiment of a presentation board digitizer system, constructed and operative according to the teachings of the present invention;

FIG. 14 illustrates another alternative exemplary embodiment of a transmitter device in accordance with this invention;

FIG. 15 is a block diagram of electronic circuitry of the transmitter device of FIG. 14; and

FIG. 16 illustrates exemplary control signals provided by the transmitter control block of FIG. 15.

### DETAILED DESCRIPTION OF THE INVENTION

The invention is embodied in marking devices for digital transcription systems. A system according to the invention intelligently uses the available battery power to operate. In addition, the invention provides marking device systems that are easily accessible and replaceable by the user.

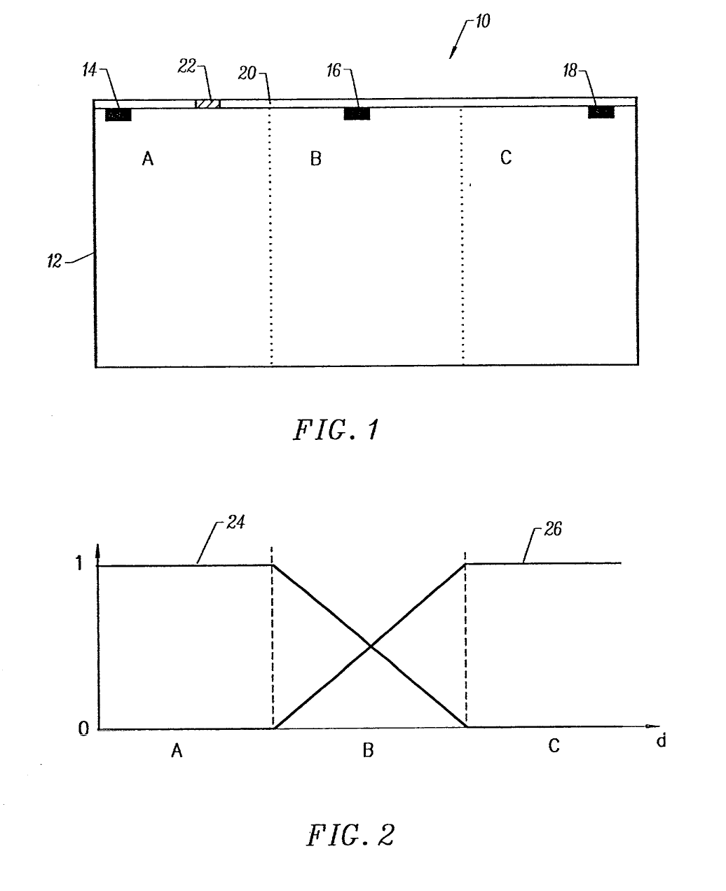

Referring now to the drawings, FIG. 1 shows a presentation board digitizer system, generally designated 10, constructed and operative according to the teachings of the present invention, showing a switch-over zone between regions with different groups of ultrasound receivers.

Generally speaking, system 10 features a presentation board 12, which may be of any conventional type, provided with a plurality of ultrasound receiver assemblies 14, 16 and 18. Ultrasound receiver assemblies 14, 16 and 18 are preferably mounted in a strip 20 adapted for convenient attachment to presentation boards of different sizes and thickness. This attachment may be achieved through clamps or clips of any type. Strip 20 also features an infrared (IR) receiver 22. System 10 operates with a movable element having both ultrasound and infrared transmitters, an example of which will be described in detail below. The present position of the movable element is derived from the time-of-flight (TOF) of ultrasound signals from the movable element to the receiver assemblies by triangulation. The IR signal provides synchronization information, as well as carrying additional information such as, for example, the color of a pen being used.

In principle, two ultrasound receivers are sufficient to uniquely determine the position of a movable element in contact with board 12. However, to provide reliable ultrasound reception over the entire area of a large board, system 10 employs more than one set of receivers. Thus, in the system as illustrated, a first set of receivers is defined as the pair of ultrasound receiver assemblies 14 and 16, and a second set of receivers is defined as the pair of ultrasound receiver assemblies 16 and 18. Clearly, the first set of ultrasound receivers so defined is well positioned for receiving an ultrasound signal from the transmitter when the movable element is in a first region denoted A, and the second set of ultrasound receivers is well positioned for receiving the signal when the movable element is in a second region denoted C. Thus, optimal precision and reliability is achieved by deriving the position of the movable element from the outputs of ultrasound receiver assemblies 14 and 16 when the movable element is in region A, and from the outputs of ultrasound receiver assemblies 16 and 18 when the movable element is in region C.

To avoid possible discontinuities in the tracking of the position of the movable element as it traverses board 12, preferred embodiments of the present invention provide a switch-over zone, denoted B, between regions A and C. Within switch-over zone B, the current position of the movable element is derived based on a weighted function of the positions calculated from the outputs of the first and second sets of receivers. Preferably, the weighted function varies smoothly with position across switch-over zone B, such that it approaches the value calculated from the first set of receivers when the movable element borders first region A and approaches the value calculated from the second set of receivers when the movable element borders second region C.

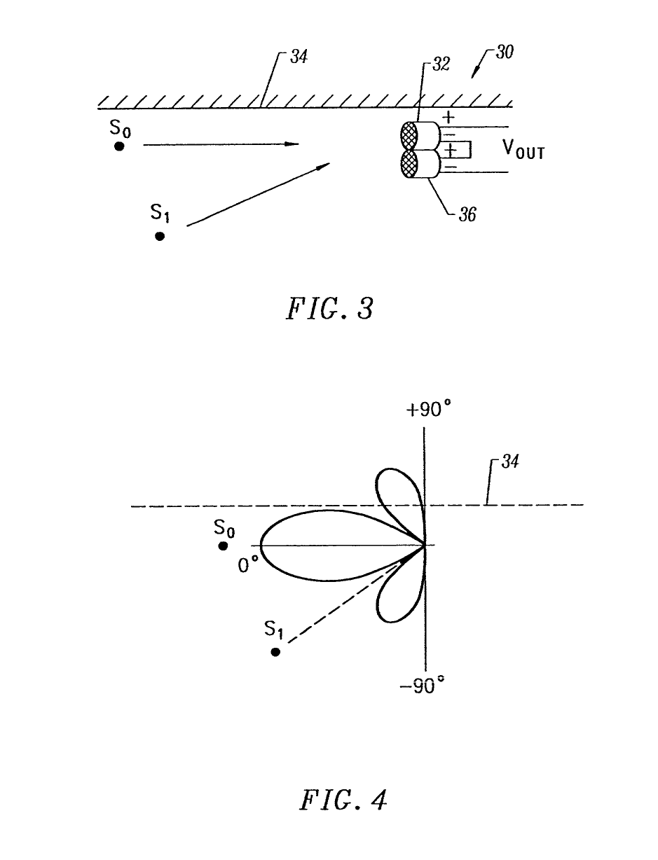

FIG. 2 shows a typical variation of the weighting function with distance across board 12. Here, plot 24 corresponds to the weighting factor applied to the first group of ultrasound receivers, and plot 26 corresponds to the weighting factor applied to the second group of ultrasound receivers. In this example, the variation within switch-over zone B is shown as linear. However, it should be appreciated that other more complex functions may be used as desired. Within region A, plot 24 is preferably constant at 1 and plot 26 is zero, whereas within region C, these values are reversed.

Calculation of the current position of the movable element according to the system described requires calculation of weighting factors which are themselves a function of position. This apparent circularity of calculation may be circumvented in a number of ways. Most simply, since the position is measured repeatedly at short intervals,, it is reasonable to assume that the new current position is a relatively small distance from the previously measured position. It is therefore reasonable to employ the last measured position for calculating the weighting factors for the subsequent measurement. Alternatively, or for the purposes of making an initial measurement, an approximate measurement may be made with some arbitrary weighting factor such as, for example, 0.5 for each set.

Although the concept of the switch-over zone has been illustrated in a simple implementation with only two sets of receivers, the concept can clearly be extended to more complex arrangements of multiple sets of receivers, both co-linearly and on opposite sides of a board. In the latter case, the weighting factor becomes a function of position in two dimensions, as will be clear to a person of ordinary skill in the art.

In addition to the switch-over zone algorithm, it is preferable that the ultrasound receivers are located sufficiently close to provide some degree of redundancy of measurement. This redundancy can then be employed (typically independent of the switch-over zone considerations) to provide a self test for accuracy and to identify any erroneous measurements which may occur temporarily.

Specifically, if receivers 14, 16 and 18 are collinear with equal spacing, A, and the distance from each receiver as measured by TOF calculations is s₁, s₂ and s₃, respectively, simple trigonometry dictates that:

s₁²−2s₂²+s₃²=2A² (constant)

By calculating this sum whenever three simultaneous TOF measurements are available, the system can continuously test that it is functioning within an acceptable margin of accuracy. If a significant error is found, further statistically based self-analysis algorithms may be implemented to identify which receiver produced the erroneous reading, and to temporarily exclude that receiver from position calculations.

Turning now to FIGS. 3 and 4, a preferred design of ultrasound receiver assembly, generally designated 30, constructed and operative according to the teachings of the present invention, for use with presentation board digitizer systems will now be described. Assembly 30 may be used to advantage with a wide range of digitizer systems, including but not limited to system 10 described above.

Generally speaking, ultrasound receiver assembly 30 includes a first ultrasound receiver 32 located adjacent to the surface 34 of the presentation board, and a second ultrasound receiver 36 displaced from first ultrasound receiver 32 in a direction substantially perpendicular to surface 34.

First and second ultrasound receivers 32 and 36 are connected so as to generate a total output signal corresponding to the instantaneous sum of the amplitudes of ultrasound signals which they receive. Typically, for simple transducers, this is achieved by connecting them in series such that their output voltages are additive.

FIG. 4 shows a plot in polar coordinates of the variation of sensitivity of assembly 30 with angle of incidence in a plane perpendicular to the surface 34. The phase differences between ultrasonic vibrations reaching the two receivers, when added, result in pronounced variation of the sensitivity of assembly 30 with angle of incidence, as shown. Specifically, the maximum sensitivity of assembly 30 occurs in a plane central to the main lobe of FIG. 4 corresponding to a plane of symmetry between receivers 32 and 36. Signals arriving at the two receivers which are incident from this plane necessarily have zero path and phase difference, thereby producing a maximum amplitude output signal. Reception from the n=1 side lobes is preferably minimized by use of a cover element (not shown) which shields assembly 30 from sound incident at large angles from surface 34.

By arranging assembly 30 as described, the plane of maximum sensitivity is oriented substantially parallel and adjacent to surface 34. This is ideal for receiving signals incident from near the presentation board (SO). Conversely, assembly 30 exhibits greatly reduced sensitivity to signals (S 1) incident from further away from the presentation board. These directional properties greatly help to isolate the ultrasound signals of importance to the digitizer system, increasing the signal to noise ratio. This allows the use of lower transmitter intensities and/or larger boards, and solves problems caused by a wide range of common noise sources. The sensitivity profile of assembly 30 parallel to surface 34 remains substantially omnidirectional similar to the profile of an individual receiver.

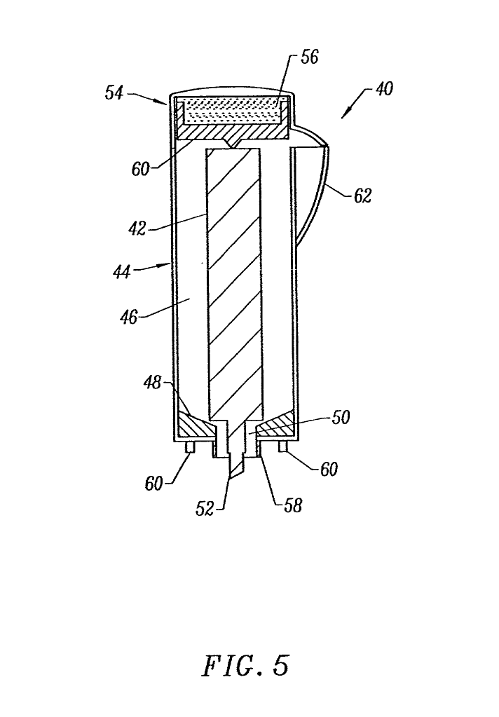

Turning now to FIGS. 5, an illustrative embodiment of a transmitter device, generally designated 40, constructed and operative according to the teachings of the present invention, for use with a drawing implement 42 in a digitizer system will be described. Transmitter device 40 may be used to advantage with a wide range of ultrasound based digitizer systems including, but not limited to, the presentation board digitizer systems described above.

Generally speaking, transmitter device 40 includes a housing 44 having a substantially cylindrical opening 46 which terminates at its lower end in an annular wedge surface 48 having a central bore 50. Drawing implement 42 is received within opening 46 with its operative tip 52 extending through central bore 50.

Transmitter device 40 also includes a retainer 54 in the form of a cover attachable to the upper end of opening 46 to retain drawing implement 42 in position within housing 44. Retainer 54 features a spring element 56 for biasing drawing implement 42 towards annular wedge surface 48. An ultrasound transmitter 58 is mounted on the lower surface of housing 44 proximal to central bore 50.

It is a particular feature of preferred embodiments of the transmitter device of the present invention that they can accommodate drawing implements of a range of lengths and widths. To this end, spring element 56 adjusts to any variations in length, and biases drawing implement 42 towards the lower end of housing 44 to ensure a correct position for use. This biasing, in conjunction with the shape of annular wedge surface 48, serves to center the front end of a drawing implement of any size or shape. In addition, spring element 56 is preferably provided with a shaped abutment surface 60 having features for centering the back end of a drawing implement. Typically, abutment surface 60 has an axial conical projection as shown for centering drawing implements by engaging a rear axial recess which is common to almost all presentation board pens. Alternatively, abutment surface 60 may be formed with a conical recess or other features for centering the back of a drawing implement.

The combination of annular wedge surface 48 and spring element 56 with abutment surface 60 serves to hold drawing implements of a range of lengths and widths in central alignment within cylindrical opening 46 without contacting the sides of housing 44. This arrangement makes transmitter device 40 insensitive to variations in drawing implement width. The avoidance of frictional contact with the sides of housing 44 is also important for efficient operation of a contact sensing microswitch, as will be described below.

It is a particular feature of certain preferred embodiments of the present invention that ultrasound transmitter 58 is formed as a substantially cylindrical piezoelectric transmitter element attached to the lower end of housing 44 around central bore 50. This arrangement ensures that, when in use, the cylindrical transmitter is coaxial with drawing implement 42, circumscribing a part of drawing implement 42 proximal to operative tip 52. As a result of the symmetry of this arrangement, TOF measurements of the position of drawing implement 42 are completely independent of axial rotation of transmitter device 40. Furthermore, the position of operative tip 52 can be determined very precisely by adding the radial dimension of transmitter cylinder 58 to the value calculated from the TOF.

Transmitter device 40 also typically features at least one element of an electromagnetic communications link, typically IR transmitter 59, and preferably about four such transmitters spaced around the lower end of housing 44. This ensures that at least one IR transmitter will be correctly oriented facing an IR receiver mounted on the presentation board at any time. It should be noted that a reversed arrangement in which an IR link is formed with a board-mounted transmitter and device 40 carries a receiver also falls within the scope of the present invention. Furthermore, the IR link may be dispensed with entirely if three ultrasound receivers are used to calculate each position. However, the arrangement described is preferred for providing higher precision than a purely ultrasound-based system while avoiding the need for complex IR signal processing circuitry in the transmitter device. Additionally, the IR transmitter allows transmission of extra information such as pen color and the like.

Ultrasound transmitter 58 and IR transmitters 59 are actuated under the control of electronic circuitry which is preferably battery powered. In the embodiment shown in FIG. 5, the electronic circuitry and the battery may be located in compartment 62 of housing 44.

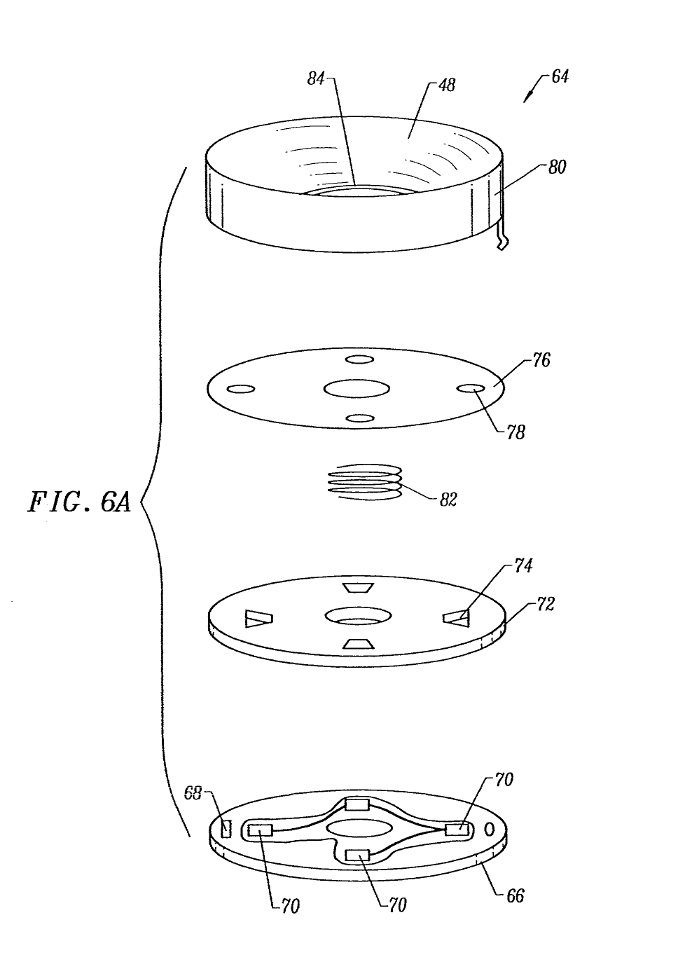

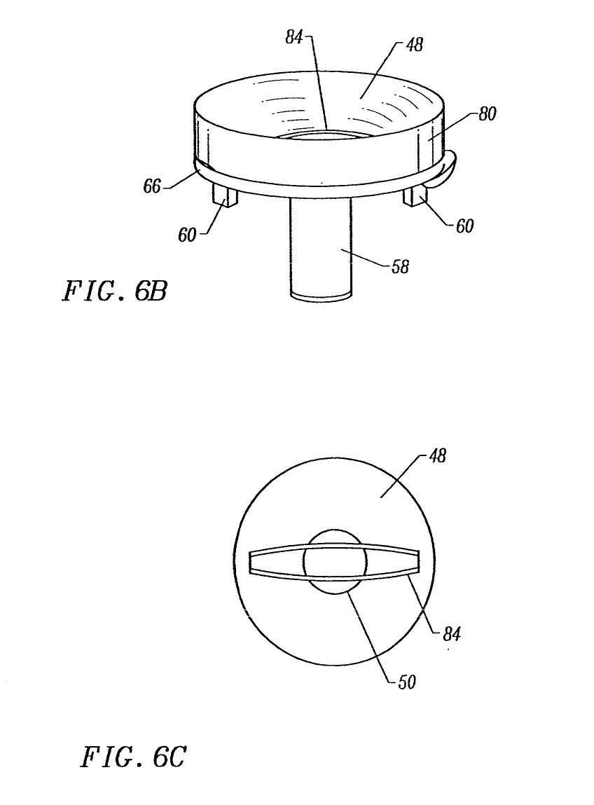

Transmitter device 40 preferably also features a switch for detecting contact between operative tip 52 and the surface of a writing board. This switch is associated with the electronic circuitry and is employed to actuate ultrasound transmitter 58 and IR transmitters 59. Preferably, the switch is formed as a microswitch positioned to respond to changes in the force applied by drawing implement 42 against annular wedge surface 48. FIGS. 6A-6C show a preferred construction for such a microswitch, generally designated 64, constructed and operative according to the teachings of the present invention.

Microswitch 64 is formed from three functional layers. First, a base layer 66 provides the terminals of the microswitch, a single peripheral contact 68 and a set of common contacts 70, spaced-apart around the center of base layer 66. On top of base layer 66 lies a layer of conductive resilient foam 72 having cut-out holes 74 opposite contacts 70. A third rigid conducting layer 76 lies above foam layer 72. Conducting layer 76 has small conductive downward projections 78 aligned with holes 74. An upper cover 80, integrally formed with annular wedge surface 48, attaches loosely to base layer 66 to unify the structure while allowing sufficient vertical motion for operation of the switch. Each layer has a central bore, together corresponding to central bore 50 of FIG. 5.

In a non-compressed state, conductive contact is made between peripheral contact 68 and foam layer 72 and between foam layer 72 and upper conducting layer 76. However, the switch remains open because the thickness of foam layer 72 prevents contact between projections 78 and inner contacts 70. When pressure is applied to compress microswitch 64, foam layer 72 becomes compressed until projections 78 come into contact with inner contacts 70, thereby closing the switch. In principle, release of the pressure allows the foam layer to return to its initial state, thereby breaking the circuit. However, in practice, the relaxation response time of the foam material is typically quite slow. For this reason, a spring 82 is mounted between base layer 66 and upper conductive layer 76 such that, when the pressure is released, upper conductive layer 76 is lifted immediately to break the circuit.

It will be clear that, when drawing implement 42 is not in use, spring element 56 urges drawing implement 42 downwards against annular wedge surface 48 so as to close microswitch 64. When drawing implement 42 is used to draw on a presentation board, a force is exerted on operative tip 52 of drawing implement 42 towards housing 44, causing drawing implement 42 to recoil slightly against spring element 56. This reduces the pressure exerted on annular wedge surface 48 the circuit of microswitch 64 opens. The electronic circuitry of transmitter device 40 is responsive at least to opening of microswitch 64 to affect a signal transmitted by transmitter device 40.

FIG. 6B shows microswitch 64 assembled, together with ultrasound transmitter 58 and IR transmitters 59. FIG. 6C shows a pair of spring elements 84 which are mounted within annular wedge surface 48 so as to grip the end of a drawing implement inserted through central bore 50. This ensures that the upper layer of microswitch 64 is sensitive to movements of drawing element 42.

The structure described here for microswitch 64 is by way of example only. Alternative structures may be used such as, for example, a switch based on a piezoelectric pressure sensor or the like. Finally, with regard to microswitch 64, correct operation of the switch depends on a degree of freedom of axial motion of drawing implement 42 against spring element 56. For this reason, it is important that spring element 56 is not fully compressed when retainer 54 is attached. FIG. 7 shows an example of a preferred structure for attachment of retainer 54 to housing 44, in which lateral projections 86 engage channels 88 which are shaped to provide a margin of release 90 when fully engaged. Margin of release 90 is designed to be at least sufficient to allow an operative range of motion of microswitch 64.

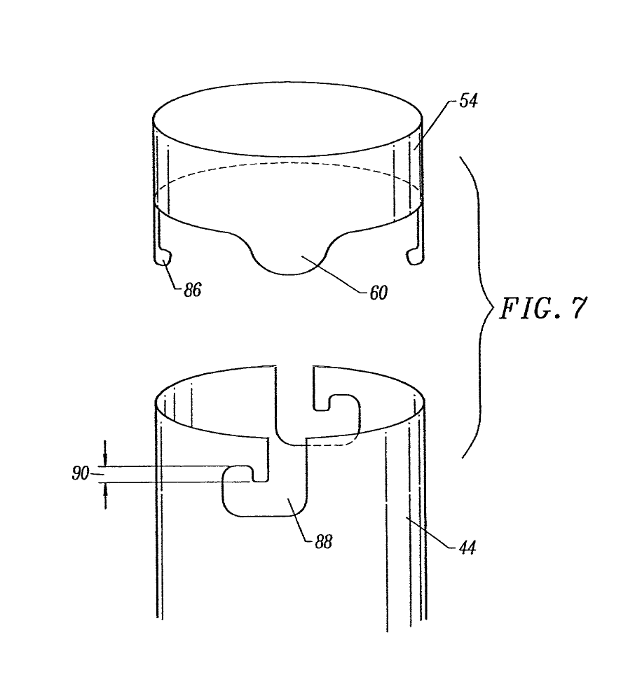

Another exemplary embodiment of transmitter devices in accordance with this invention is shown in FIG. 8. Similar to the embodiment shown in FIG. 5, transmitter device 140 is intended for use with drawing implement 42. Transmitter device 140 also features housing 144 with cylindrical opening 146. However, cylindrical opening 146 now terminates at its lower end with a gasket 92. Gasket 92 features a central bore 150, through which operative tip 52 of drawing implement 42 extends.

Holder 154, which is hingedly attached to the upper end of housing 144 with hinge 94, acts to hold drawing implement 42 substantially centered within opening 146. Holder 150 locks onto housing 144 by a locking pin 96. Holder 150 features a first spring element 98 for biasing drawing implement 42 within opening 146. Preferably, first spring element 98 is stronger than second spring element 100. A cover 102 is also provided for drawing implement 42.

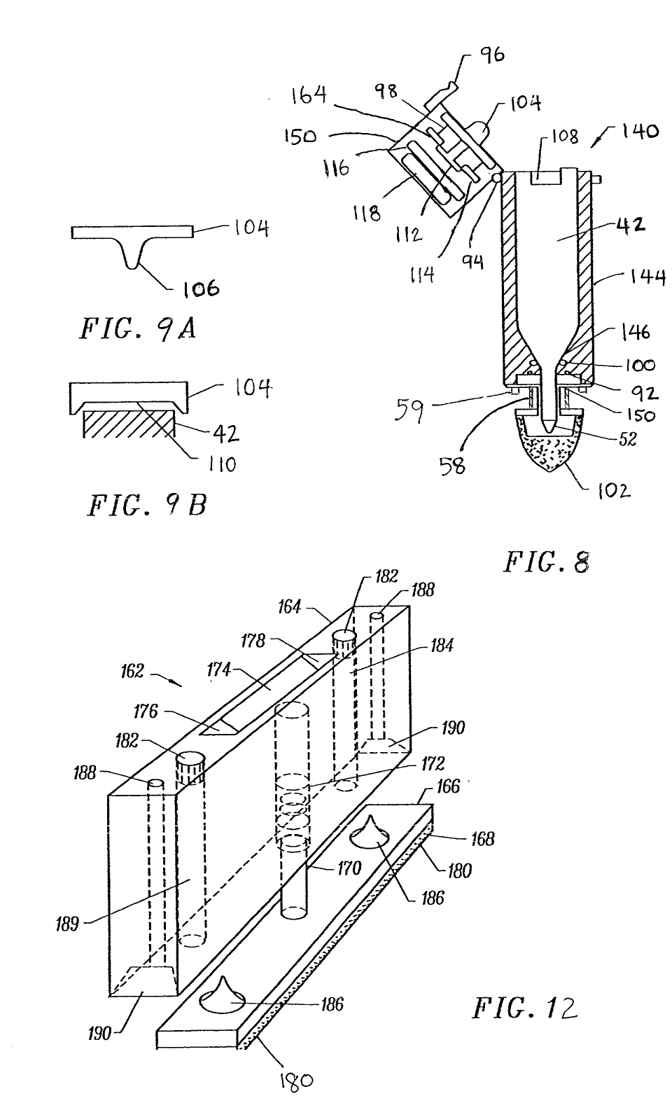

To retain drawing implement 42 in the centered position, holder 150 preferably has an upper biasing element 104. Upper biasing element 104 can be in one of two shapes, as shown in FIGS. 9A and 9B. FIG. 9A shows upper biasing element 104 with an axial conical projection 106 for centering drawing implement 42 by engaging a rear axial recess 108 which is common to most presentation board pens. However, this embodiment is potentially restricted to use only with presentation board pens having axial recess 108 with a particular diameter, as axial recess 108 is not of uniform diameter between pens. Alternatively, upper biasing element 104 features a recess 110 into which the upper end of drawing implement 42 is inserted, as shown in FIG. 9B. This embodiment has the advantage of being usable with most presentation board pens, since the external diameter of these pens is generally uniform.

Referring again to FIG. 8, the combination of upper biasing element 104, gasket 92 and spring elements 98 and 100 has the advantage of holding drawing implements of a variety of lengths and external diameters in central alignment within cylindrical opening 146 substantially without contacting the sides of housing 144. As described above for FIG. 5, the avoidance of frictional contact with the sides of housing 144 is also important for efficient operation of a contact sensing microswitch 164.

Holder 150 also has a pressure-sensitive element 164, which has two parts, a pin 112 and a printed circuit board 114. Pin 112 contacts upper biasing element 104, sensing when contact is made between drawing implement 42 and the presentation board. In combination, these two parts allow transmitting device 140 to sense when contact has been made with the presentation board.

Transmitting device 140 also features ultrasound transmitter 58 and IR transmitter 59, similar to the embodiment shown in FIG. 5. Ultrasound transmitter 58 and IR transmitters 59 are actuated under the control of electronic circuitry 116 which is preferably battery powered by a battery 118. Both electronic circuitry 116 and battery 118 are preferably located in holder 150 of housing 144.

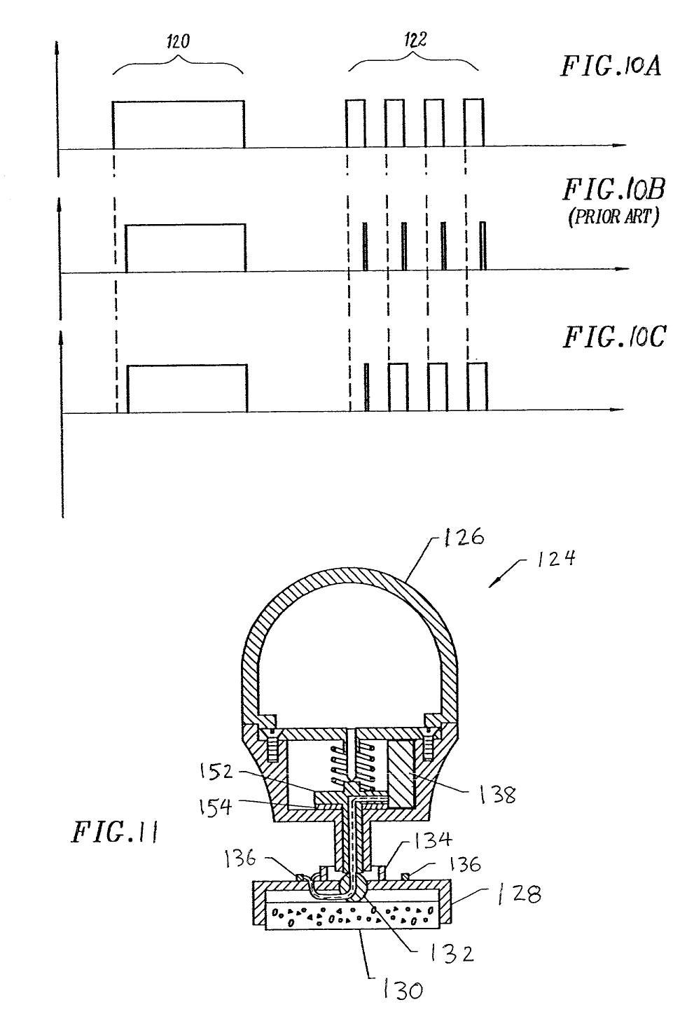

Turning to FIGS. 10A-10C, a preferred transmission profile of transmitter device 40 (and 140) will now be described. FIG. 10A represents a contact profile of drawing element 42 as measured by microswitch 64 (and 164) as a function of time. During a first period 120, drawing implement 42 is kept in contact with the presentation board for an extended period to draw a continuous shape. Then, during a second period 122, drawing implement 42 is used in a series of short, separate strokes to form a dashed line.

As mentioned above, the prior art digitizer systems suffer from a significant delay in picking-up the beginning of each pen stroke. This is because the transmitters are actuated each time pen contact is made, and interrupted each time pen contact ceases. As a result, each pen stroke starts with a dead time during which the receiver system synchronizes and locks on to the transmitted signals. The results of this system are shown in FIG. 10B. During period 120, the effects are not very serious. There is a small signal loss at the beginning of the period, but the great majority of the stroke is recorded well. During period 122, however, the system response time is comparable to the length of the pen strokes. As a result, the dashed line is almost completely lost.

To solve this problem, the present invention is preferably designed to maintain synchronization between transmitter device 40 and the receiver system for a given period after the end of each pen stroke. Typically, this is achieved by the electronic circuitry continuing to operate IR transmitters 59 for the given time interval after microswitch 64 (and 164) ceases to indicate a force exerted on the outer housing towards the operative tip of the drawing implement. False drawing signals can be avoided either by the electronic circuitry disabling ultrasound transmitter 58 during the delay period, or by changing the content of the IR signal to indicate a non-contact pen state. The delay period is typically at least about half a second, and preferably between about 1 and about 2 seconds.

FIG. 10C illustrates the response profile of transmitter device 40 as described. During an initial period of a single pen stroke, its response is not dissimilar from that of the prior art. However, when short repeated strokes are encountered, transmitter device 40 maintains synchronization between successive strokes, thereby providing an accurate response immediately on switching of microswitch 64.

Turning now to FIG. 11, an eraser, generally designated 124, constructed and operative according to the teachings of the present invention, for use with a presentation board digitizer systems will be described. A major problem with eraser elements for use with digitizer system is the common practice of employing only a part of the eraser surface. Because the digitizer is typically unable to distinguish between flat contact and edge contact of the eraser, the digitized image frequently shows a much greater erased area than has actually been cleared from the presentation board itself. To solve this problem, eraser 124 is constructed such that its eraser surface is self orienting to lie parallel to the presentation board surface. This ensures that the contact area of the eraser element is always precisely defined.

Thus, eraser 124 has a handle 126 and an eraser element 128 which has a substantially flat, eraser surface 130. Handle 126 and eraser element 128 are connected by a pivot joint 132, typically in the form of a ball-and-socket, which has two degrees of rotational freedom. The use of pivot joint 132 ensures that, in use, eraser element 128 assumes an orientation with eraser surface 130 parallel to the presentation board surface substantially independent of the orientation at which handle 126 is held.

Eraser 124 also features transmitter device features analogous to those of transmitter device 40 described above. These include a cylindrical ultrasound transmitter element 134, a number of IR transmitters 136 and an electronic circuitry/battery block 138. Connection of handle 126 to pivot joint 132 is through a sprung pin assembly 152. A pressure sensing microswitch 154 is mounted in the seat of pin assembly 152 for sensing contact pressure between handle 126 and eraser element 128. Wiring from electronic circuitry 138 to transmitters 134 and 136 is preferably located axially within pin assembly 152 and passing through pivot joint 132.

Eraser surface 130 is preferably circular, and cylindrical ultrasound transmitter element 134 is preferably arranged such that its axis is aligned with the center of eraser surface 130. By addition of the radius of the cylinder to the TOF measurements, this arrangement allows precise identification of the center of the circle of erasure, and hence of the entire area covered by eraser surface 130. Eraser 124 thus provides a much higher degree of precision and determination of the erased area than can be achieved by prior art devices.

An alternative embodiment of an eraser 162 is shown in FIG. 12. Eraser 162 is designed for erasing a small area, particularly an area of narrow width, and can thus be described as a “narrow-band eraser.” Similarly to eraser 124, eraser 162 has a handle 164 and an eraser element 166 which has a substantially flat eraser surface 168. However, handle 164 is connected to eraser element 166 by a pressure-sensitive element 170. Pressure sensitive element 170 includes a spring 172, such that when at least a portion of eraser surface 168 contacts the presentation board, a signal is transmitted to a touch switch 174. Touch switch 174 preferably includes a printed circuit board 176 and electrical circuitry 178, which enable touch switch 174 to identify when eraser surface 168 contacts the presentation board. This is similar to pressure sensing microswitch 154 of eraser 124.

A second method of identification of touching of the presentation board uses the following features of eraser 162. Eraser surface 168 has two contact microswitches 180, preferably located substantially at each end of eraser surface 168, which are substantially similar in function to contact microswitch 64 of FIG. 6. If only one contact microswitch 180 senses contact with the presentation board, only a small area will be erased, such as a letter, for example. If, however, both contact microswitches 180 sense contact with the presentation board, a zone with the length and width of eraser surface 168 will be erased.

Similarly to eraser 124, eraser 162 also has transmitter device features. Specifically, eraser 162 has at least one, and preferably two, cylindrical ultrasound transmitters 182, located in handle 164, preferably substantially at each end of handle 164. Because each ultrasound transmitter 182 is located in handle 164, eraser 162 also features an ultrasound conductor tube 184 for each ultrasound transmitter 182. Each ultrasound conductor tube 184 goes from handle 164 to eraser element 166, such that the ultrasound signal from each ultrasound transmitter 182 is transmitted downward. Eraser 162 also has a reflector cone 186 for each ultrasound transmitter 182. Reflector cone 186 is preferably located in eraser element 166, reflecting the ultrasound waves in all directions.

Eraser 162 also has two infrared transmitters 188, preferably located substantially at each end of handle 164. Each infrared transmitter 188 has an infrared reflector 190, also located in handle 164, which serves a similar function as reflector cone 186.

Although one particular embodiment of these transmitter device features has been described, it will be appreciated that a number of different embodiments are possible, substantially as described above for the transmitter device.

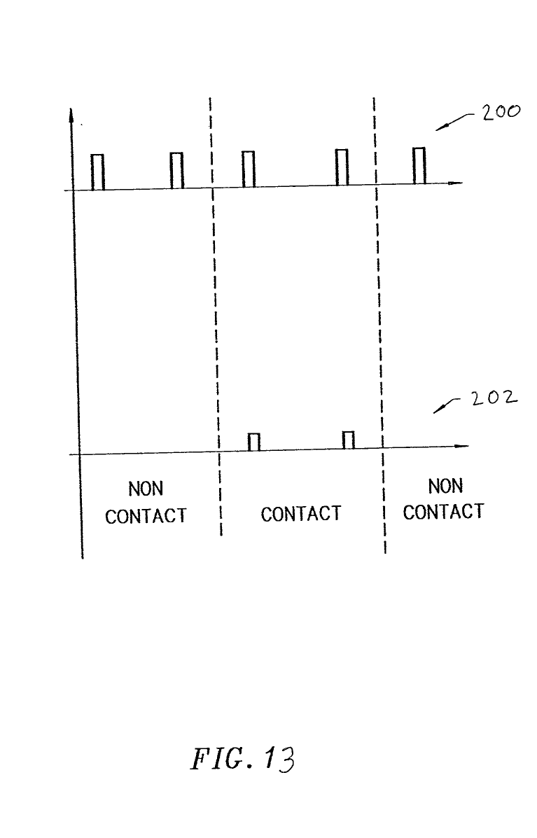

Referring now to FIG. 13, the operation of a further embodiment of a transmitter device, constructed and operative in accordance with this invention, is described for use with a presentation board digitizer system. This device is generally similar to transmitter devices 40 (and 140) described above, except that it dispenses with microswitch 64 (and 164), instead identifying pen-board contact by transmission of vibrations through the board.

As mentioned earlier, digitizer systems employing through-the-board transmission suffer from poor accuracy and dependency on specific board design. However, they have a major advantage of inherent pen-board contact identification. The device of the present invention combines this feature with all the advantages of precision and independence from board design provided by air-borne ultrasound systems, using the through-the board detection solely for contact detection.

Thus, this embodiment may be used with a presentation board system essentially similar to that of FIG. 1, with the addition of a transducer associated with the board (not shown) for detecting vibrations from the transmitter conducted through the board. The processor of the receiver system is then responsive to outputs from the airborne ultrasound receivers to calculate a current position of the transmitter, and to the output from the board mounted transducer to identify contact between the drawing implement and the board, thereby identifying operative strokes of the drawing implement.

The principle of this system is shown clearly in FIG. 13 in which plot 200 represents the signal from one of the ultrasound receiver assemblies and plot 202 represents the signal from the board-mounted transducer. Plot 200 shows a continuous sequence of pulses since the transmitters operate continuously as long as the pen is in use, according to this embodiment. Plot 202, on the other hand, only registers corresponding pulses during a period that the pen is in contact with the board. Although the signal quality of plot 202 is typically inferior, it is more than sufficient for identification of contact or non-contact conditions.

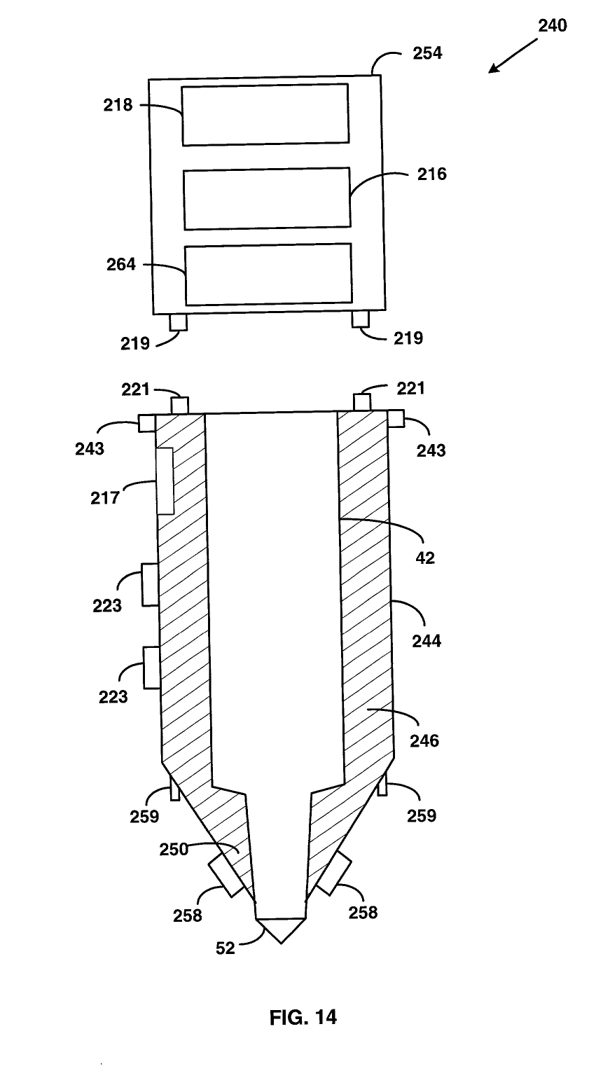

Referring now to FIG. 14, another exemplary transmitter device in accordance with this invention is described. Transmitter device 240 includes retainer 254, housing 244, ultrasound transmitter 258 and IR transmitter 259. Drawing implement 42 is received within opening 246 inside housing 244, and includes an operative tip 52 that extends through bore 250 of housing 244. Retainer 254 may be coupled to an end of housing 244, and includes microswitch 264 for detecting contact between operative tip 52 and the surface of a writing board (similar to microswitch 64 of FIG. 6), electronic circuitry 216 and battery 218. Ultrasound transmitter 258 and IR transmitters 259 are actuated under the control of electronic circuitry 216 which is preferably battery powered by battery 218.

Retainer 254 may be detachably coupled to housing 244. For example, retainer 254 may snap ON and OFF housing 244. Alternatively, retainer 254 may be hingedly or slidably coupled to housing 244. In addition, housing 244 may include circuitry 217 that couples to circuitry 216 to permit circuitry 216 to identify the color of drawing implement 42. A removable collar 243, or other similar device may be used to indicate the color of the drawing implement inside housing 244.

Retainer 254 also includes electrical contacts 219 that couple to corresponding electrical contacts 221 on housing 244. Electrical contacts 219 are used by retainer 254 to couple electronic circuitry 216 with electronic circuitry 217 for reading the housing's color indicator, and for providing electrical power to and controlling ultrasound transmitter 258 and IR transmitters 259.

Transmitter device 240 optionally also may include one or more buttons or switches 223 located on retainer 254 and/or housing 244. Buttons 223 may be used to define various functions for use with the transcription system. For example, buttons 223 may be used to define button functions such as: next page, print, clear page, copy page, copy selection, etc. As described below, electronic circuitry 216 may be configured to detect the selection of buttons 223 and communicate the associated functions to the electronic transcription system.

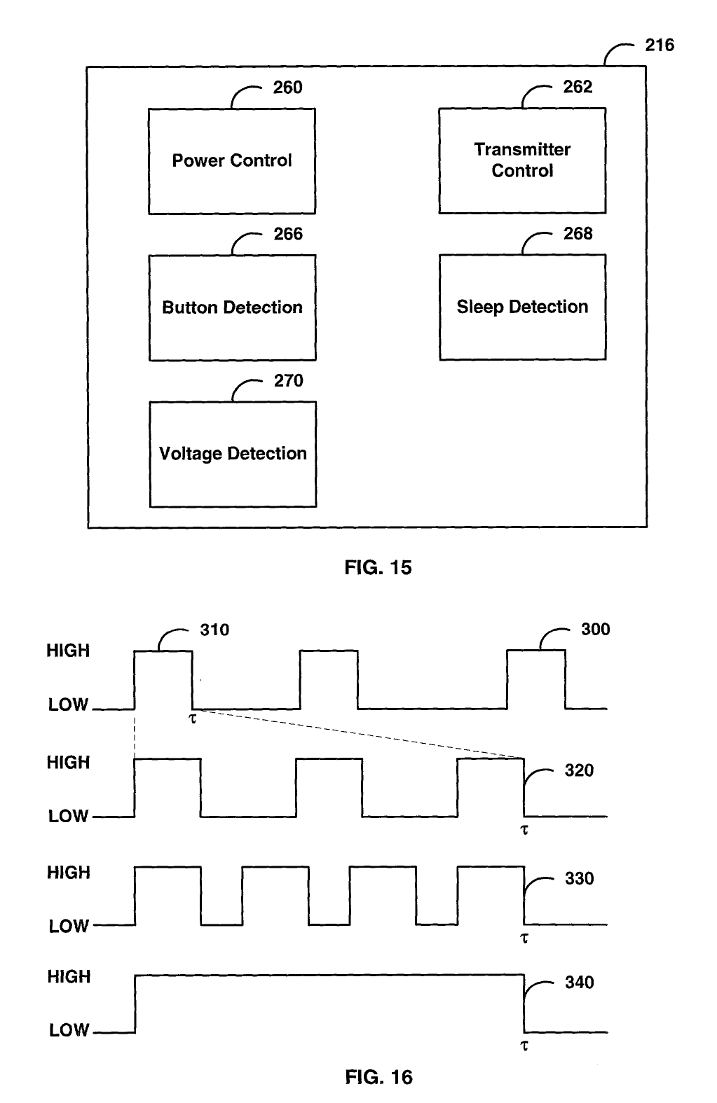

Referring now to FIG. 15, electronic circuitry 216 will be described in block diagram form. Electronic circuitry includes power control block 260, transmitter control block 262, button detection block 266, sleep detection block 268 and voltage detection block 270. The functions of each of these blocks is described below.

Power control block 260 controls power to housing 244 and ultrasound transmitter 258 and IR transmitters 259. Power control block 260 optionally may disconnect electrical power from electrical contacts 219 if retainer 254 is detached from housing 244. For example, power control block 260 may sense the existence of electronic circuitry 217 (such as a resistor) in housing 244 to determine if the sleeve is attached. By disconnecting power from electrical contacts 219, power control block 260 prevents a user from receiving an electrical shock by touching the contacts.

Transmitter control block 262 controls signals transmitted by ultrasound transmitter 258 and IR transmitters 259. In particular, transmitter control block 262 controls the control signal waveforms applied to ultrasound transmitter 258 and IR transmitters 259.

Button detection block 266 senses that a user has pressed one of buttons 223, and then sends a signal that the button has been pressed across the IR transmitters 259. The transcription system receives the indication that a particular button has been pressed and looks up the function definition for that button and performs the defined function.

Sleep detection block 268 monitors the time since the last use of the transmitter device 240 by the user (either by using the transmitter device as a pen or pressing a button). After a predetermined time, for example two minutes, sleep detection block 268 may place the transmitter device in a “sleep” or reduced-power state. Sleep detection block 268 may then “wake up” upon any detected activity on the transmitter device 240, such as the transmitter device 240 being used as a pen or any of buttons 223 being pressed, and may place the transmitter device in a full-power state.

To eliminate the need for a voltage regulator, voltage detection block 270 and transmitter control block 262 may vary the IR transmitter signal depending on the voltage of battery 218. FIG. 16 illustrates various control signals that may be used to control the IR transmitter, such as IR transmitter 259 of a transmitter device in accordance with this invention. An IR receiver used in a conventional electronic transcription system typically is designed to detect IR pulses such as those generated by control signal 300, which includes individual control pulse 310 that varies between LOW and HIGH. IR detectors, however, typically are relatively insensitive to fluctuations in the IR pulse. As a result, IR pulse 310 may be transmitted as a series of pulses whose combined pulse width equals τ (such as pulses 320 or 330), or as a single pulse having a pulse width τ (such as pulse 340).

To save power, an alternative embodiment of transmitter devices in accordance with this invention vary the control signal to IR transmitter 259 as a function of the voltage level of battery 218. In particular, voltage detection block 270 (FIG. 15) checks the voltage level of battery 218. If the voltage level is greater than a predetermined value, e.g., 5.5 volts, transmitter control block 262 generates a control signal for IR transmitter 259 using a waveform such as waveform 320, in which the control signal has a HIGH value for less than the full period τ (i.e., a duty ratio of less than 1). In the example shown in FIG. 16, waveform 320 has a duty ratio of approximately ⅓. Persons of ordinary skill in the art will understand, however, that the specific duty ratio is not critical, and may have values other than ⅓.

As the voltage level of battery 218 decreases, voltage detection block 270 and transmitter control block 262 change the number and duration of control pulses applied to IR transmitter 259. For example, if voltage detection block 270 determines that the voltage level is less than 5.5 volts, but greater than a second predetermined level, such as 4 volts, transmitter control block 262 generates a control signal for IR transmitter 259 using a waveform such as waveform 330, in which the control signal has a duty ratio greater than the duty ratio of waveform 320 (e.g., approximately ¾). Persons of ordinary skill in the art will understand, however, that the specific duty ratio is not critical, and may have values other than ¾.

As the voltage level of battery 218 further decreases, voltage detection block 270 and transmitter control block 262 further change the number and duration of control pulses applied to IR transmitter 259. For example, if voltage detection block 270 determines that the voltage level is less than the second predetermined level (e.g., 4 volts), transmitter control block 262 generates a control signal for IR transmitter 259 using a waveform such as waveform 340, in which the control signal has a duty ratio greater than the duty ratio of waveform 310 (e.g., approximately 1). At this point, the battery voltage level is fairly low, and the output level of IR transmitter 259 will also be low, so a full waveform is likely needed so that the IR detector in the transcription system can recognize the IR pulse.

One skilled in the art will readily appreciate that different discrete voltage level checks as well as the number of checks can be used. Additionally, the battery levels detected by the electronic circuit do not have to be discrete levels, but can be continuously variable.

Persons of ordinary skill in the art will understand that the functions performed by electronic circuitry 216 may be implemented in hardware or software, or various combinations of hardware and software. Persons of ordinary skill in the art further will recognize that methods and apparatus in accordance with this invention may be implemented using steps or devices other than those shown and discussed above. All such modifications are within the scope of the present invention, which is limited only by the claims that follow.

1. A transmitter device for an electronic transcription system, the transmitter device comprising:
a housing adapted to receive a drawing implement, the housing comprising a first electronic circuit that identifies a color of the drawing implement;
a retainer coupled to the housing, the retainer comprising a second electronic circuit that may be coupled to the first electronic circuit to detect the color of the drawing implement.

2. The transmitter device of claim 1, wherein the housing further comprises an ultrasound transmitter and an infrared transmitter.

3. The transmitter device of claim 1, wherein the housing further comprises a removable collar for indicating the color of the drawing implement.

4. The transmitter device of claim 1, wherein the retainer further comprises a microswitch adapted to detect contact between an operative tip of the drawing implement and a surface of a writing board.

5. The transmitter device of claim 1, wherein the retainer further comprises a battery.

6. The transmitter device of claim 1, wherein the retainer is detachably coupled to the housing.

7. The transmitter device of claim 1, wherein the retainer is hingedly coupled to the housing.

8. The transmitter device of claim 1, wherein the retainer is slidably coupled to the housing.

9. The transmitter device of claim 1, wherein the housing further comprises a button that may be used to define a function for the transcription system.

10. The transmitter device of claim 1, wherein the second electronic circuit further comprises a power control circuit that controls power to the housing.

11. The transmitter device of claim 10, wherein the housing further comprises electrical contacts, and the power control circuit disconnects power from the electrical contacts when the retainer is detached from the housing.

12. The transmitter device of claim 1, wherein the second electronic circuit further comprises a sleep detection circuit that places the transmitter device in a reduced-power state on the occurrence of a first predetermined condition.

13. The transmitter device of claim 1, wherein the second electronic circuit further comprises a sleep detection circuit that places the transmitter device in a full-power state on the occurrence of a second predetermined condition.

14. The transmitter device of claim 1, wherein the second electronic circuit further comprises a voltage detection block.

15. The transmitter device of claim 14, wherein the retainer further comprises a battery, and the voltage detection block detects a voltage level of the battery.

16. The transmitter device of claim 1, wherein:
the retainer further comprises a battery;
the second electronic circuit comprises a transmitter control circuit and a voltage detection circuit, the voltage detection circuit detecting a voltage level of the battery; and
wherein the transmitter control circuit provides a first control signal when the voltage level exceeds a first predetermined value.

17. The transmitter device of claim 16, wherein the transmitter control circuit provides a second control signal when the voltage level is less than the first predetermined value and greater than a second predetermined value.

18. The transmitter device of claim 16, wherein the transmitter control circuit provides a third control signal when the voltage level is less than a third predetermined value.
